(19) United States
(12) Patent Application Publication
(10) Pub. No.: US 2005/0120366 A1
(43) Pub. Date: Jun. 2, 2005

(54) Determining viewer watching behaviour from recorded event data

(75) Inventor: Joseph Anthony Thurbon, Leichhardt (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/976,756

(22) Filed: Nov. 1, 2004

(30) Foreign Application Priority Data
Nov. 28, 2003 (AU) 2003906612

(51) Int. Cl. H04N 7/16; H04H 9/00

(52) U.S. Cl. 725/9; 725/14; 725/135; 725/13

(57) ABSTRACT

A method (300) of determining whether a viewer (101) has watched a program is disclosed. The method (300) comprises the steps of accumulating program flipping data (1000) for the program, determining metadata for the program, selecting in a step (315) an algorithm dependent on the metadata, and applying, in a step (320) the selected algorithm to the program flipping data (1000), to thereby extract in a step (330) intentional viewing data that establishes if the program has been watched by the viewer.

### FIELD OF THE INVENTION

The present invention relates generally to Television (TV) program watching behaviour, and in particular to the identification of programs that a viewer has watched based on their program channel flipping behaviour.

### BACKGROUND

There is significant interest, among different organisations, in determining which television (TV) programs are watched by the viewing public. Some of these organisations, referred to as ratings collectors, are interested in the behaviour of large groups of viewers in order to generate broad viewing statistics. Such statistics are typically not concerned with the viewing habits of individual viewers. Other organisations, referred to as personalisation collectors, are interested in the habits of individual viewers.

A viewer is defined as watching a program if he or she concentrates a significant amount of their attention on the program. In contrast, a viewer is defined to be merely viewing a program if he or she idly glances at the program, or even stares “through” the program, without paying any particular attention to the program.

A number of techniques have been adopted by the personalisation collectors in order to obtain their data. Personal interviews and questionaires have been used, however this is expensive and time consuming and needs to be repeated frequently to track changes in viewers behaviour. Furthermore, viewers are not always objective in answering questions about their viewing behaviour.

Another approach adopted by personalisation collectors has been to record data relating to viewer's physical interactions with their televisions and related equipment such as video cassette recorders (VCRs) and Digital Video Disk (DVD) players. This type of data provides, for instance, time-series data of which channels were viewed, when they were viewed and for how long. Such data is referred to as program flipping data. Since a viewer may, however, simply flip past channel “A” while actually searching for channel “B”, there is clearly a difference between program flipping data and data about the channels to which the viewer has actually watched and paid attention. Time series data about this latter type of intentional viewing behaviour is referred to as intentional watching data.

Different techniques have been used to extract intentional watching data from program flipping data, however these techniques suffer from various shortcomings.

### SUMMARY OF THE INVENTION

This specification describes how intentional watching data can be derived from a record of the viewer's program flipping data. In the disclosed approach, one or more “surface characteristics” of the program flipping data are used as a basis for selecting one or more processing methods from a set of available methods. The selected method(s) are then applied to the program flipping data to extract the desired intentional watching data.

According to a first aspect of the present disclosure, there is provided a method of determining whether a viewer has watched a program, the method comprising the steps of:
accumulating program flipping data for the program;
determining metadata for the program;
selecting an algorithm dependent on the metadata; and
applying the selected algorithm to the program flipping data, to thereby extract intentional viewing data that establishes if the program has been watched by the viewer.

According to another aspect of the present disclosure, there is provided a system for determining whether a viewer has watched a program, the system comprising:
means for accumulating program flipping data for the program;
means for determining metadata for the program;
means for selecting an algorithm dependent on the metadata; and
means for applying the selected algorithm to the program flipping data, to thereby extract intentional viewing data that establishes if the program has been watched by the viewer.

According to another aspect of the present disclosure, there is provided a system for determining whether a viewer has watched a program, the system comprising:
at least one processor; and
at least one program module for directing the processor to execute a method for determining whether the viewer has watched the program, said at least one program module comprising:
code for accumulating program flipping data for the program;
code for determining metadata for the program;
code for selecting an algorithm dependent on the metadata; and
code for applying the selected algorithm to the program flipping data, to thereby extract intentional viewing data that establishes if the program has been watched by the viewer.

According to another aspect of the present disclosure, there is provided a computer program for directing a processor to execute a method of determining whether a viewer has watched a program, the program comprising:
code for accumulating program flipping data for the program;
code for determining metadata for the program;
code for selecting an algorithm dependent on the metadata; and
code for applying the selected algorithm to the program flipping data, to thereby extract intentional viewing data that establishes if the program has been watched by the viewer.

According to another aspect of the present disclosure, there is provided a computer program product including a computer readable medium having recorded thereon a computer program for directing a processor to execute a method of determining whether a viewer has watched a program, the program comprising:
code for accumulating program flipping data for the program;
code for determining metadata for the program;
code for selecting an algorithm dependent on the metadata; and
code for applying the selected algorithm to the program flipping data, to thereby extract intentional viewing data that establishes if the program has been watched by the viewer.

According to another aspect of the present disclosure, there is provided information about whether a viewer has watched a program, the information having been determined by a method comprising the steps of:
accumulating program flipping data for the program;
determining metadata for the program;
selecting an algorithm dependent on the metadata; and
applying the selected algorithm to the program flipping data, to thereby extract intentional viewing data that establishes if the program has been watched by the viewer.

According to another aspect of the present disclosure, there is provided information about program flipping data used in a method for determining whether a viewer has watched a program, the program flipping data comprising viewing events characterised by at least one of a channel identifier, an event duration, and a channel event state being one of ON, OFF, UP, DOWN and SET.

According to another aspect of the present disclosure, there is provided information about program flipping data used in a method for determining whether a viewer has watched a program, the program flipping data comprising viewing events characterised by at least one of a duration, and a program state being one of ON, OFF, FAST FORWARD, CUE FORWARD, FAST REWIND and SET.

According to another aspect of the present disclosure, there is provided a method of improving a viewing angle between at least one viewer watching a TV and the TV, the method comprising the steps of:
detecting spatial information about said at least one viewer relative to the TV; and
adjusting orientation of the TV to improve the viewing angle.

According to another aspect of the present disclosure, there is provided an apparatus for improving a viewing angle between at least one viewer watching a TV and the TV, the apparatus comprising:
means for detecting spatial information about said at least one viewer relative to the TV; and
means for adjusting orientation of the TV to improve the viewing angle.

Other aspects of the invention are also disclosed.

### BRIEF DESCRIPTION OF THE DRAWINGS

Some aspects of the prior art and one or more embodiments of the present invention will now be described with reference to the drawings in which:

FIG. 1 shows a system that enables intentional watching data to be determined;

FIG. 2 shows the set top box of FIG. 1 in more detail;

FIG. 3 shows the PC of FIG. 1 in more detail;

FIG. 4 shows a pictorial example of program flipping data;

FIG. 5 shows the program flipping data of FIG. 4 augmented with presence data;

FIG. 6 shows a flowchart of method steps for extracting intentional watching data from recorded program flipping data according to the described arrangement;

FIG. 7 shows a flowchart of method steps for the threshold method step in FIG. 6;

FIG. 8 shows a flow chart of method steps for the visit method step in FIG. 6;

FIG. 9 shows program flipping data and presence data for incorporation into the visit method; and

FIG. 10 shows a TV mounted on a rotatable stand for improving viewing angles for multiple viewers.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions, contained in the “Background” section and in the section above, relating to prior art arrangements, relate to discussions of documents or devices which form public knowledge through their respective publication and/or use. Such should not be interpreted as a representation by the present inventor(s) or patent applicant that such documents or devices in any way form part of the common general knowledge in the art.

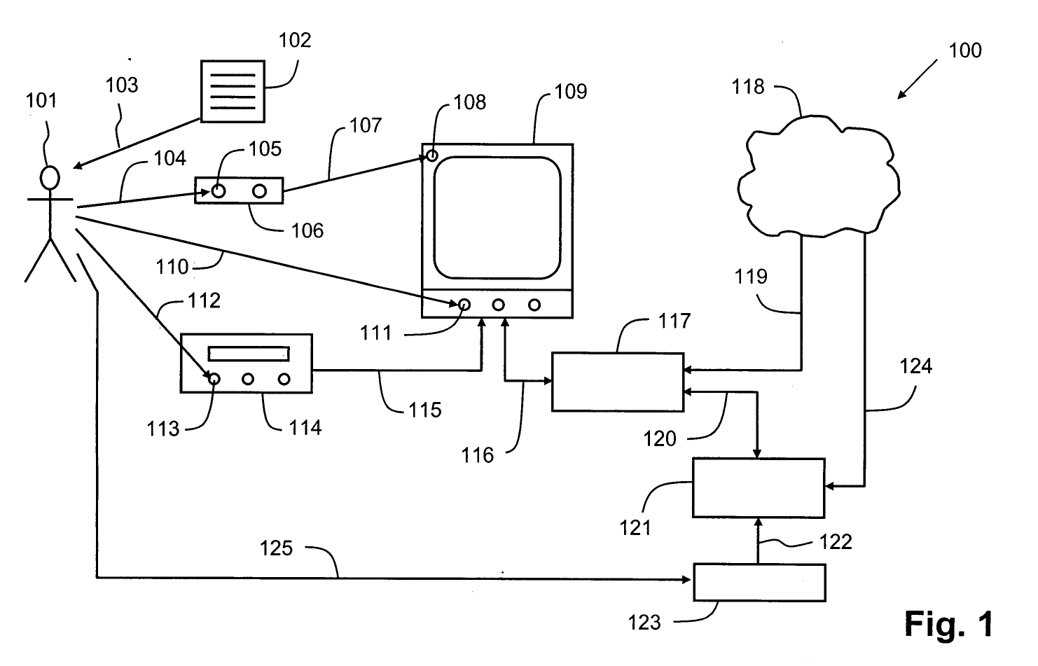

FIG. 1 shows a system 100 which enables the intentional watching data for a viewer 101 to be determined. The viewer 101 extracts, as depicted by an arrow 103, TV program data, referred to as program meta-data, from a paper TV program guide 102. TV program meta-data includes start-times and end-times of programs, program title, program genre, cast members and so on. According to this meta-data the viewer 101 operates, as depicted by an arrow 104, a button 105 on a TV remote control 106. This button operation is referred to as a viewer event. The remote control 106 sends an infra-red (IR) signal, depicted by an arrow 107, to an IR detector 108 on a TV receiver 109.

Alternately, the viewer 101 activates, as depicted by an arrow 110, a control 111 on the TV, this being another viewer event. Alternately the viewer, having found nothing of interest in the TV guide 102 activates, as depicted by an arrow 112, a control 113 on a VCR 114 (this being a further viewer event) which sends associated program material, as depicted by an arrow 115 to the TV 109. Clearly the VCR 114 could be a DVD player or another form of TV program playback device. The TV presents the desired program to the viewer 101 according to whichever control information (depicted by one of 104, 110, and 112) the viewer 101 has asserted. The assertion of each control action is associated with a corresponding viewer event.

Instead of extracting TV program data from the paper TV guide 102, Electronic Program Guide (EPG) meta-data can be provided, as depicted by an arrow 119, from a network 118 to a set top box 117 that sits on top of the TV 109 in the viewer's lounge. The set top box 117 is connected to the TV as depicted by an arrow 116. The viewer can view EPG data on the TV 109 prior to making his or her program selection by operating one or more of the controls such as 105, 111 or the like, on the remote control 106, the TV 109, or the set top box 117. Again, program selection in this manner constitutes a viewer event.

Alternately, the EPG data can be provided from the network 118, as depicted by an arrow 124, to a general purpose personal computer (PC) 121. The PC 121 provides the EPG data, as depicted by an arrow 120, to the set top box 117, which sends it to the TV 109 as previously described. Alternately, the EPG data can be displayed on the PC 121. The viewer 101 can interact with the PC 121 using a keyboard 123 that is connected, as depicted by an arrow 122, to the PC 121, this interaction 125 constituting a viewer event. This selection is communicated by the PC via 120 to the set top box 117.

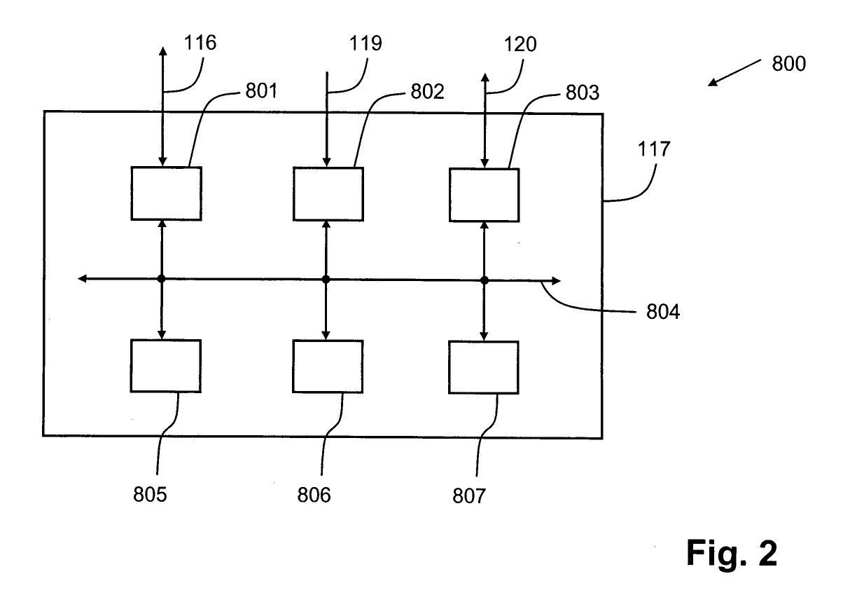

FIG. 2 shows the set top box 117 of FIG. 1 in more detail. The set top box 117 has a TV interface module 801 that is connected to a communication and data bus 804. A network communication interface module 802 is also connected to the bus 804, as is a PC interface module 803. The set top box 117 also has a processor 805, a read-only memory (ROM) module 806 and a random access memory (RAM) module 807 connected to the bus 804. The set top box can also contain other modules such as hard disk drives and so on, in a similar manner to that explained in more detail in regard to the PC 121 below.

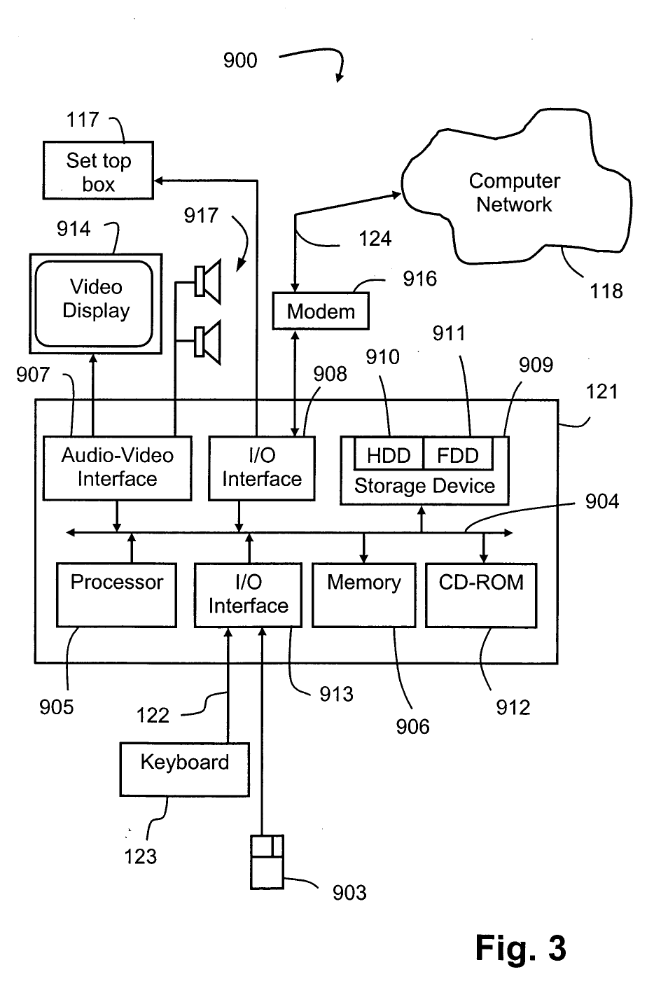

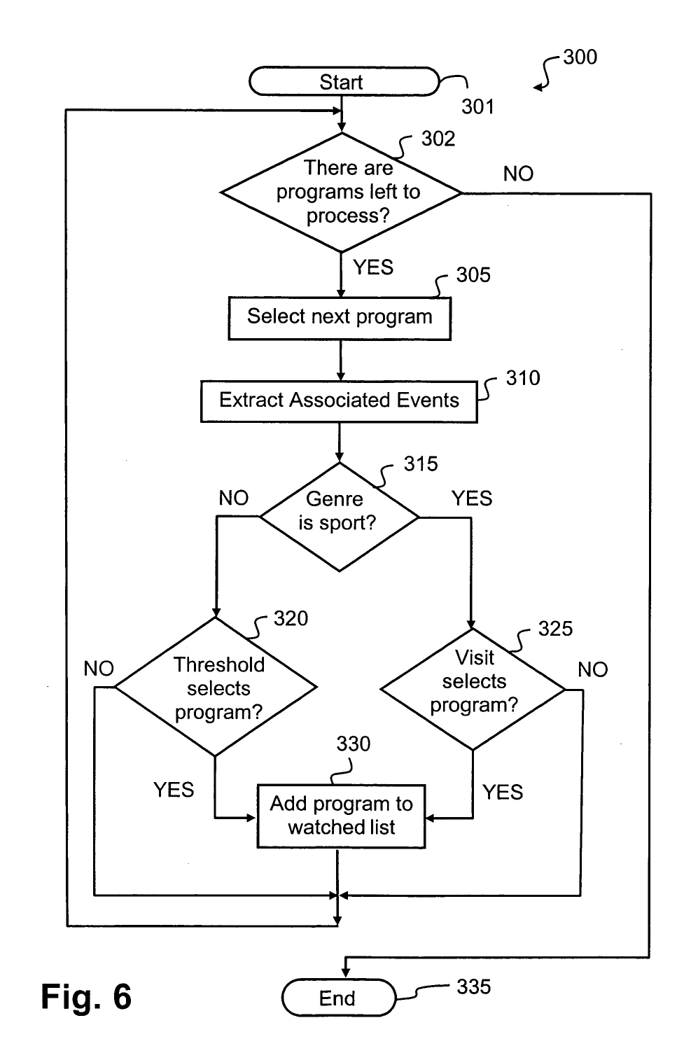

FIG. 3 depicts a general-purpose personal computer (PC) system 900 which is a suitable platform for implementing the disclosed intentional watching data extraction method described in relation to FIG. 6. The processes described in relation to FIGS. 6-8 may be implemented as software, such as an application program executing within the computer system 900. In particular, the method steps for intentional watching data extraction are effected by instructions in the software that are carried out by the computer 121. The instructions may be formed as one or more code modules, each for performing one or more particular tasks. The code modules can be organised along functional lines as depicted in FIGS. 6-8.

The software may also be divided into two separate parts, in which a first part performs the intentional watching data extraction methods, and a second part manages the user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for extracting intentional watching data.

The computer system 900 is formed by a computer module 121, input devices such as a keyboard 123 and mouse 903, output devices including a display device 914 and loudspeakers 917. A Modulator-Demodulator (Modem) transceiver device 916 is used by the computer module 121 for communicating to and from the communications network 118, for example connectable via a telephone line 124 or other functional medium. The modem 916 can be used to obtain access to the Internet, and other network systems, such as a Local Area Network (LAN) or a Wide Area Network (WAN), and may be incorporated into the computer module 121 in some implementations.

The computer module 121 typically includes at least one processor unit 905, and the memory unit 906, for example formed from semiconductor random access memory (RAM) and read only memory (ROM). The module 121 also includes a number of input/output (I/O) interfaces including an audio-video interface 907 that couples to the video display 914 and loudspeakers 917, an I/O interface 913 for the keyboard 123 and mouse 903 and optionally a joystick (not illustrated), and an interface 908 for the modem 916 and the set top box 117 via a connection 120.

In some implementations, the modem 916 may be incorporated within the computer module 121, for example within the interface 908. A storage device 909 is provided and typically includes the hard disk drive 910 and a floppy disk drive 911. A magnetic tape drive (not illustrated) may also be used. The CD-ROM drive 912 is typically provided as a non-volatile source of data. The components 905 to 913 of the computer module 121, typically communicate via an interconnected bus 904 and in a manner which results in a conventional mode of operation of the computer system 900 known to those in the relevant art. Examples of computers on which the described arrangements can be practised include IBM-PC's and compatibles, Sun Sparcstations or alike computer systems evolved therefrom.

Typically, the application program is resident on the hard disk drive 910 and read and controlled in its execution by the processor 905. Intermediate storage of the program and any data fetched from the network 118 may be accomplished using the semiconductor memory 906, possibly in concert with the hard disk drive 910. In some instances, the application program may be supplied to the user encoded on a CD-ROM or floppy disk and read via the corresponding drive 912 or 911, or alternatively may be read by the user from the network 118 via the modem device 916. Still further, the software can also be loaded into the computer system 900 from other computer readable media.

The term “computer readable medium” as used herein refers to any storage or transmission medium that participates in providing instructions and/or data to the computer system 900 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 121. Examples of transmission media include radio or infra-red transmission channels as well as a network connection to another computer or networked device, and the Internet or Intranets including e-mail transmissions and information recorded on Websites and the like.

The system 100 in FIG. 1 records the viewer events as a program flipping time-series record. Each viewer event (depicted, for example, by the arrows 104, 110, 112 or 125) is communicated to the set top box 117 whose processor 805 time stamps each viewer event, correlates the viewer event with associated system data such as the program to which the system has been directed by the viewer event, and stores the resultant program flipping data in the set top box RAM module 807. Alternately, the program flipping data can be communicated to the PC 121. The PC processor 905 can process the viewer events and the associated system data and store the resultant program flipping data in the PC hard disk 910.

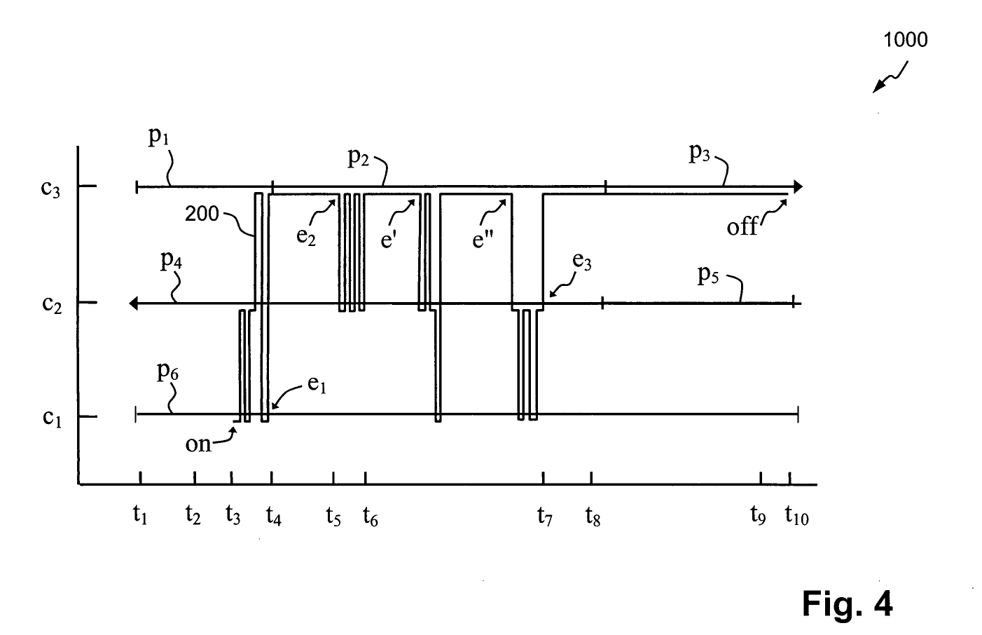

FIG. 4 shows one example 1000 of program flipping data. The data relates to three TV channels (c₁, c₂, c₃), and six television programs (p₁, . . . ,p₆). The TV programs (p₁, . . . ,p₆) commence at one of the times (t₁, t₄, t₈). The viewer 101 turns ON the TV 109 at the time t₃. This viewing event and the subsequent viewing events are depicted by an event line 200. The vertices of the event line 200 (ie the break points between horizontal and vertical line segments of the event line 200) correspond to viewer events. These viewer events are the control actions by the viewer 101 (such as depicted by the arrows 104, 110, 112 and 125 in FIG. 1). As is described in relation to presence data however, viewer events are not restricted to control actions of the viewer 101. In the present example, the event line 200 tracks the state of the TV channel selection, as the viewer 100 changes channels. Clearly, the event line 200 could also track the state of other system variables including sound parameters (such as sound volume), picture parameters (such as brightness) and so on.

After switching ON the TV 109 at the time t₃, the viewer 101 changes channels frequently from the time t₃ until a time t₄ when, corresponding to a viewer event e₁, the user 101 tunes the TV 109 to the channel c₃. The time t₄ corresponds to the start of the TV program p₂ on the channel c₃. From the time t₄ the event line 200 remains flat while the TV 109 is tuned to the program p₂. At a time t₅, commencing with a viewer event e₂, the viewer 100 begins to flip rapidly between the channels c₂ and c₃ until the time t₆. This channel flipping behaviour might occur because there are commercials showing during this period on the channel c₃. Alternately, it may be that the viewer 100 has simply lost interest in the program p₂. The channel flipping continues until the time t₆ after which the event line 200 again remains flat while the TV 109 is tuned to the program p₂ on the channel c₃. Another two sets of rapid channel flipping take place as depicted by events e′ and e″. The event line 200 is flat between the flipping that commences at the events e′ and e″ and the TV is tuned to the channel c₃, while the program p₂ is being shown.

After the event e₃, the event line 200 is flat until the TV is turned off at the event OFF. This may indicate that the viewer was viewing the end of the program p₂ and the beginning of the program p₃. Alternately, the viewer 101 may have left the room at some time between the event e₃ and the event OFF.

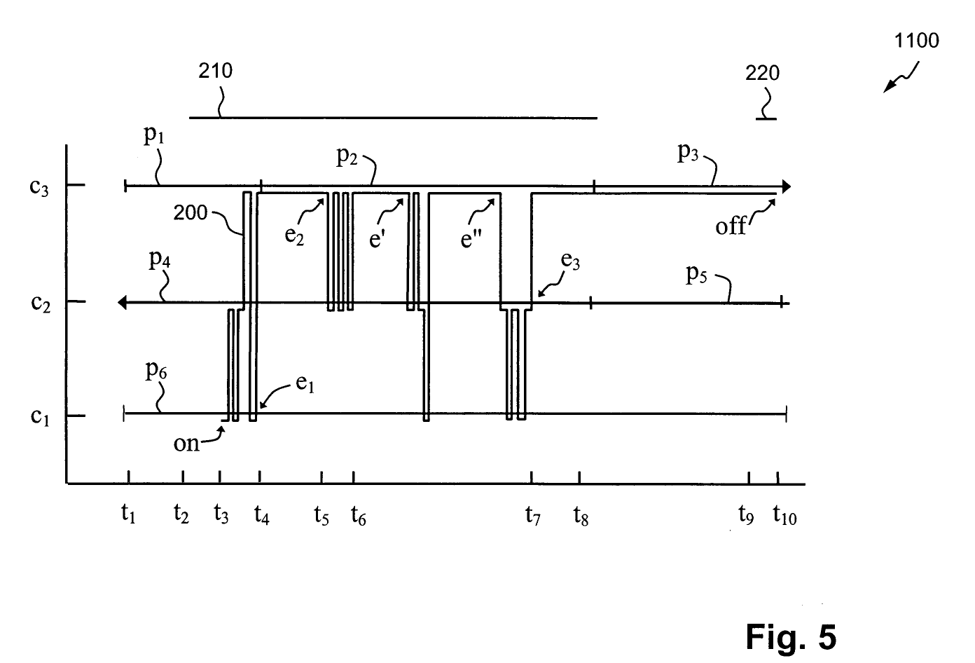

In an alternate arrangement of the system 100 in FIG. 1, an additional infra-red detector (not shown) may be incorporated into either the TV 109 or the set top box 117 to detect the presence of the viewer 101 by detecting black-body IR radiation given off by the viewer 101. In yet another arrangement, ultrasonic or other detectors (not shown) may be used to detect the presence of the viewer 101 in the room. The presence or absence of the viewer in the room may be incorporated into the program flipping data as shown in FIG. 5.

FIG. 5 incorporates presence data 210 and 220 for the viewer 101 onto the event line 200 of FIG. 4. From the presence line 210 it is seen that the viewer entered the room with the TV at the time t₂ and the viewer 101 switched on the TV at the event ON at the time t₃. The presence line shows that the viewer 101 left the room at the end of the program p₂, and only returned to the room at the time t₉. Shortly thereafter, at the time t₁₀, the viewer switched the TV off at the event OFF and left the room as shown by the presence line 220. Clearly when the presence detecting capability is incorporated into the system 100, the augmented system is capable of detecting and recording the presence data 210, 220 irrespective of whether the TV 109 is switched on or off. The disclosed method of incorporating presence data can also handle presence data which is only collected when the TV is ON.

Each viewing event in FIG. 4 such as ON, e₁-e₃, e′, e″, and OFF, has an effect on the state of the television 109. The duration of a viewing event is defined as the duration of the effect of the viewer event. When considering viewing events flowing purely from the user 101 using the remote control 106, each viewing event corresponds to a button such as 105 on the remote control 106 being pressed. The duration of a viewing event is the elapsed time until the occurrence of the subsequent viewing event, this being initiated by another remote button being pressed. Clearly in another example there could be viewer events related to the user's operation of controls not on the remote control 106, such as the button 113 on the VCR 114, and the button 111 on the TV 109, and the interaction with the keyboard 123 associated with the PC 121.

In the present example, the event e₁ (see FIG. 4) tunes the television 109 from the channel c₁ to the channel c₃ at the time t₄. The TV 109 remains on the channel c₃ until the event e₂ at the time t₅ tunes the television from the channel c₃ to the channel c₂. The period from t₄ to t₅ is referred to as the duration of the viewer event e₁. Since the viewer event e₁ sets the television to channel c₃, the channel c₃ is defined as the channel of the event c₃. Similarly, the television program p₁ has an associated duration (<t₁ . . . t₄>) and an associated channel c₃.

A viewer event is defined as being associated with a program if the duration of the viewer event overlaps the duration of the program. A viewer event will thus be associated with all programs that are showing when that event takes place. Thus, for example, the event e₁ is associated with the programs p₁, p₂, p₄, and p₆.

A viewer event is defined to be coincident with a program if the event is associated with the program and the channel of the program is the same as the channel of the event. Thus, for example, in FIG. 4 the event e₂ is associated with the programs p₂, p₄ and p₆, but the event e₂ is co-incident with only the program p₄ because it tunes the television to the channel c₂.

Viewing events relating to the TV 109 are typically defined in terms of four parameters namely type, channel, starting time, and duration, and can be represented as follows:
eventᵢ=event(typeᵢ; channelᵢ; start timeᵢ; durationᵢ) [1]
where:
[1] defines the viewing event of index “i” in terms of the event type of index “i”, the channel of index “i”, the starting time of index “i” and the duration of index “i” (the index “i” is merely a representative index);
“type” is one of:
   “UP” which means that the viewer changes the TV channel setting from a channel N to a channel N+1;
   “DOWN” which means that the viewer changes the TV channel setting from a channel N to a channel N-1;
   “SET” which means that the viewer sets the channel to a channel setting M;
   “ON” which means that the viewer switches the TV on;
   “OFF” which means that the viewer switches the TV off; and
“channel” is the channel to which the event directs the TV (may be null, eg. if “type”=“OFF”.

Typically both the “UP” and the “DOWN” commands “wrap around” so that DOWN on channel ONE would set the channel to the maximum channel, and UP on the maximum channel would set the channel to channel ONE.

Viewing events relating to the VCR 114 (or equivalently to a DVD or equivalent program playback device) are typically defined in terms of four parameters, namely type, starting time, and duration, and can be represented as follows:
eventⱼ=event(typeⱼ; start timeⱼ; durationⱼ) [2]
where:
[2] defines the viewing event of index “j” in terms of the event type of index “j”, the starting time of index “j” (start time j being relative to the media, and not a measure of absolute time) and the duration of index “j” (the index “j” is merely a representative index);
“type” is one of:
   “FAST FORWARD” which means that the viewer commands the VCR or DVD to rapidly wind forward through the recorded program material;
   “FAST REWIND” which means that the viewer commands the VCR or DVD to rapidly wind backwards through the recorded program material;
   “STOP” which terminates a previously commanded FAST FORWARD or FAST REWIND command;
   “SET” which means that the viewer sets a program reference to a position in memory at which a particular program segment has been stored;
   “CUE” (or “SHUTTLE”) which means fast forward or fast backwards with picture being visible;
   “ON” which means that the viewer switches the VCR or DVD on;
   “OFF” which means that the viewer switches the VCR or DVD off.

FIG. 6 shows a process 300 that operates on recorded program flipping data in order to extract the corresponding intentional watching data that classifies a particular program as having been either watched, or merely viewed by the viewer 101. In the described example the process 300 is executed in the set top box 117. However, the process 300 could also be executed on the PC 121, or in a distributed fashion using both the set top box 117 and the PC 121. The process 300 in the present example uses program flipping data such as 1000 in FIG. 4 or 1100 in FIG. 5, which has been stored in the memory module 807 of the set top box 117. The process 300 produces as output intentional watching data including a list of the programs that were watched by the viewer 101. This list of programs in the memory module 807 of the set top box 117, can be used by other processes without having to ask the viewer 101 which programs they watched.

The process 300 begins with a start step 301 in which the processor 805 reads the program flipping data from the memory module 807. Then, at a following step 302, if there are no programs left to classify from the program flipping data (for example, the program flipping data could be a null data set, or alternately, all programs on the program flipping data could have been processed already by the process 300), then control passes according to a NO arrow to an End step 335, and the process 300 terminates. If, however, at the process 302, there are more programs to classify, then control passes according to a YES arrow to a step 305, where the next program is extracted from the list of those programs remaining in the program flipping data. Thereafter, control passes to a step 310, in which the viewer events that are associated with the program under consideration are extracted from the program flipping data, and control then passes to a step 315.

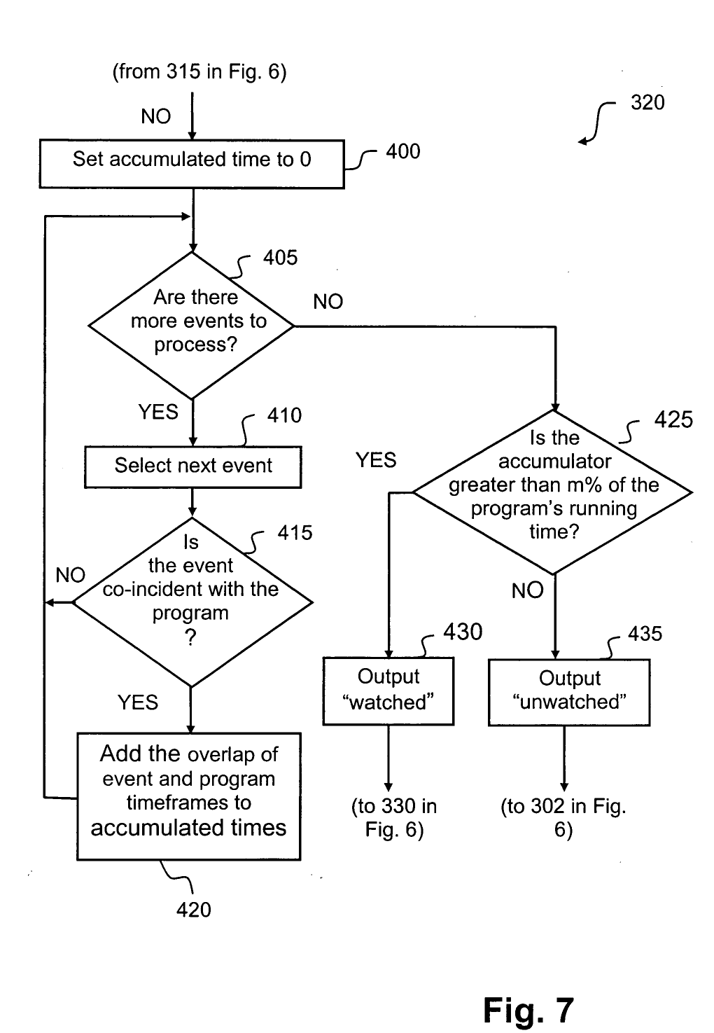

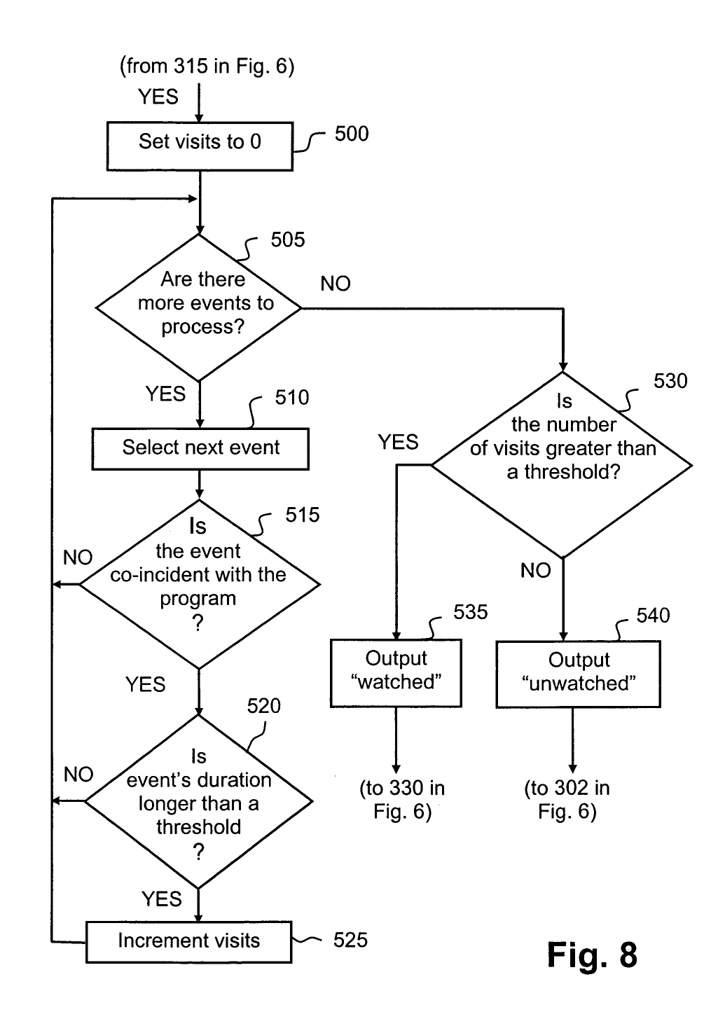

At the step 315, the program meta-data associated with the program under consideration is examined. If the genre of the program under consideration is not sport, then control passes according to a NO arrow to a step 320. Alternately, if the genre of the program being considered is sport, then control passes according to a YES arrow to a step 325. At the step 320, a threshold algorithm, which will be described below in relation to FIG. 7, is applied to the program under consideration, to see if that algorithm classifies the program under consideration as having been watched (and not merely viewed). If the threshold algorithm classifies the program under consideration as having been watched then control passes according to a YES arrow to a step 330. At the step 325, a visit algorithm, which will be described below in relation to FIG. 8, is applied to the program under consideration to see if that algorithm classifies the program under consideration as having been watched. If the visit algorithm classifies the program under consideration as having been watched, then control passes, according to a YES arrow, to the step 330.

At the step 330, the program under consideration is added to the list of programs that are classified as having been watched, this list being the intentional watching data derived from the program flipping data. The step 330 also removes the program under consideration from the list of programs, or alternately, marks it as processed. The intentional watching data is the output of the process 300. Control is then passed back to the step 302.

If at the step 320 the threshold algorithm does not classify the program as having been watched, or if at the step 325 the visit algorithm does not classify the program as having been watched, the program under consideration is removed from the list of programs and control returns to step 302.

Considering the process 300 in regard to specific program flipping data in FIG. 4, and particularly the situation in which the program selected at the step 305 of the process 300 is p₂, then the associated viewer events would be all of those viewer events whose durations at least partially overlap with the time period between t₄ and t₈. For example, the duration of the program p₂ is <t₄, . . . ,t₈>and the duration of the last event e₃ is <t₇, . . . ,t₁₀>. Therefore, the overlap between the event e₃ and the program p₂ is <t₇, t₈>, so e₃ is associated with p₂.

Several characteristics of a particular program, such as the program p₂ in FIG. 4 for example, can be determined in a straightforward manner once the viewer events associated with the program p₂ have been determined. For example, the frequency with which viewer events occur during the program at can be calculated without further analysis. It is noted that the term “frequency” in this context relates to how many events per hour occur during the program in question. Thus, for example, if during a one-minute viewing period the viewer changes channel ten times, then the frequency with which view events occur would be ten viewer events per minute. Similarly, the genre of the program under consideration can easily be determined from the program metadata. These characteristics are called surface characteristics. Some (non-exhaustive) examples of the surface characteristics of a program are event frequency, event range (the number of channels spanned by the events), and genre of the program. In one example relating to FIG. 4 t₄ is 6:00 pm, t₅ is 6:20 pm, t₆ is 6:25 pm, t₇ is 6:55 pm, and t₈ is 7:00 pm. In this example the event frequency during p₂ is 18 events per hour since there are 18 events that occur during that hour. Similarly, in the period t₅ to t₆ (this being 5 minutes) there are 6 events, and so the event frequency for that period is 72 events per hour. The event range during the period of p₂ is 3, since all three channels are tuned at some point during that period. Similarly, the event range during the period t₅ to t₆ is 2.

In contrast, the cumulative time that the television is tuned to the program over its duration, or the fact that the program had the same director as some other program are examples of non-surface characteristics, because they require either further processing of viewing events in the first case, or further searching of the metadata associated with the program in the second case. In another example relating to FIG. 4, comparison of the genre of program p₂ to another program such as p₆ would be considered a non-surface characteristic. Similarly, comparing the events with some historical data would also result in a non-surface characteristic.

Returning to FIG. 6, the step 315 uses the genre of the viewing events associated with a program to choose between the threshold selection algorithm (see FIG. 7) and the visit-based selection algorithm (see FIG. 8). If the selected algorithm determines that the program was watched, rather than merely viewed, then the program is added in the step 330 to the intentional watching list of programs that the viewer has watched. Thus, for example, if the time t₄ is 6:00 pm, t₅ is 6:20 pm, t₆ is 6:25 pm, t₇ is 6:55 pm, and t₈ is 7:00 pm, then an example of channel flipping data in regard to FIG. 4 is presented by the following table (which relates, for illustration, only to the period t₄ to t₈).

| Type | Channel | Start Time | Duration |
|---|---|---|---|
| . | . | . | . |
| . | . | . | . |
| . | . | . | . |
| SET (e₁) | C₃ | 5:59 | 21 minutes |
| DOWN (e₂) | C₂ | 6:20 | 1 minute |
| UP | C₃ | 6:21 | 1 minute |
| DOWN | C₂ | 6:22 | 1 minute |
| UP | C₃ | 6:23 | 1 minute |
| DOWN | C₂ | 6:24 | 1 minute |
| UP | C₃ | 6:25 | 11 minutes |
| DOWN (e′) | C₂ | 6:36 | 1 minute |
| UP | C3 | 6:37 | 1 minute |
| DOWN | C₂ | 6:38 | 1 minute |
| DOWN | C₁ | 6:39 | 1 minute |
| SET | C₃ | 6:40 | 9 minutes |
| DOWN (e″) | C₂ | 6:49 | 1 minute |
| DOWN | C₁ | 6:50 | 1 minute |
| UP | C₂ | 6:51 | 1 minute |
| DOWN | C₁ | 6:52 | 1 minute |
| UP | C₂ | 6:53 | 2 minutes |
| UP (t ₇) | C₃ | 6:55 | 93 minutes |
| . | . | . | . |
| . | . | . | . |
| . | . | . | . |

If is assumed that the only program having the genre of “sport” in the example is the program p₄, then the intentional viewing behaviour is as follows:
p₂ is watched, since more than one third of the program is viewed;
p₄ is watched, since it is a sports program and there are more than three visits of 60 seconds;
all other programs are unwatched.

It is noted that the only surface characteristics considered in this example relate to the genre of the program.

While the described examples use the genre of the program to select a particular algorithm to classify a single program, other surface characteristics may be used. Thus, for example, the disclosed method may use range or frequency. In another arrangement, the disclosed method may use other information about the program or its broadcast channel.

The step 320 uses the threshold algorithm to classify the program as watched or merely viewed. The step 325 uses the visit-based algorithm to classify the program as watched or merely viewed. Thereafter, if the selected algorithm classifies the program as watched, then the program is added to the list of watched programs contained in the intentional watching data. The control of the process 300 then returns to the step 302 for further processing of programs. The salient aspect of the step 315 is that a surface characteristic is used to select between a predefined set of analysis algorithms. Each of the analysis algorithms can be computationally expensive, and none of the algorithms alone is typically adequate to classify all programs as watched or merely viewed.

FIG. 7 shows a flowchart of method steps for the threshold method performed by the step 320 in FIG. 6. The list of viewing events that were extracted at the step 310 in FIG. 6 is also given to the process in FIG. 7. The process in FIG. 7 determines the proportion of time that the TV 109 was tuned to the program under consideration, and whether that proportion of time is sufficient to classify the program as having been watched rather then being merely viewed. The NO arrow from the step 315 in FIG. 6 is directed to a step 400 that sets an accumulator to 0. This accumulator, that can be implemented by the processor 805 of the set top box 117, is incremented each time a viewing event is identified that is coincident with the program under consideration.

From the step 400 the process 320 passes control to a step 405, where the list of the events (from the step 310 in FIG. 6) that are associated with the program under consideration are inspected. If that list contains any events, then control passes according to a YES arrow to a step 410. At the step 410, the next event to be considered is extracted from the aforementioned list of events, and then control passes to a step 415. At the step 415, the channel of the viewing event is compared with the channel of the program under consideration. If the channel of the viewing event is the same as that channel of the program, then control passes according to a YES arrow to a step 420. At the step 420, the overlap between the viewing event and the program under consideration is calculated, and added to the accumulator. Control then passes back to the step 405. If however at the step 415 the channel of the viewing event is not the same as the channel of the program, then the event being processed is removed from the list of events, and control passes according to a NO arrow to the step 405.

If at the step 405 the list of events is empty, then there are no events left to process and control passes according to a NO arrow to a step 425. At the step 425, the contents of the accumulator (ie the accumulated duration of overlap durations) is divided by the length (ie the total duration) of the program under consideration, yielding the proportion of the program for which the television was tuned to the program. If this proportion exceeds a predetermined threshold of “M” %, then control passes according to a YES arrow to a step 430. At the step 430, the algorithm classifies the program as watched (not merely viewed), and outputs a “WATCHED” flag to the intentional watching data. If at the step 425, the proportion does not exceed the threshold, then control passes according to a NO arrow to a step 435. At the step 435, the method 320 classifies the program as unwatched (ie as merely viewed), and outputs an “UNWATCHED” parameter to the intentional watching data. After the step 430 is completed, or after the step 435 is completed, the method 320 terminates and control passes back to method 300 in FIG. 6.

FIG. 8 shows a flow chart of method steps for the visit method performed by the step 325 in FIG. 6. Some programs are watched in a series of short bursts, rather than in a contiguous block. In particular, sports programs are often watched in this manner, as are sets of programs which are being viewed simultaneously. For example, consider a game of American football. The game is interspersed with natural breaks, which broadcasters use to broadcast commercials. During this time, the television is often tuned to another channel, perhaps for some time, before returning to the game.

Tuning to a particular channel for a predetermined period of time is called a visit to that channel. In FIG. 6, the step 325 which performs the visit method is given a program under consideration, and a list of viewing events which are associated with that program. The process 325 commences, according to the YES arrow from the step 315 in FIG. 6, whereby control is passed to a step 500, in which an accumulator counting the number of visits to the program is set to 0. The accumulator is implemented by the processor 805 of the set top box 117. At a following step 505, the list of viewing events is examined. If there are more events left in the list, then control passes according to a YES arrow to a step 510. The step 510 extracts the next viewing event from the list of events, and control passes to a step 515.

At the step 515, the channel of the event extracted in the step 510 is compared to the channel of the program under consideration. If the channel of the program is the same as the channel of the event, then control passes according to a YES arrow to a step 520. At the step 520, the duration of the viewing event is compared to a threshold, to determine whether the viewing event is a visit. If the event is longer than the threshold, the viewing event is considered to be a visit, and control passes according to a YES arrow to a step 525. At the step 525, the visit count accumulator is incremented by one.

If at the step 515 the channel of the event is not the same as the channel of the program, then the event is removed from the list of events and control passes according to a NO arrow to the step 505. If at the step 520 the duration of the event is shorter than the predefined threshold, then the event is removed from the list of events and control passes according to a NO arrow to the step 505.

If at the step 505, there are no more events in the list, control passes according to a NO arrow to a step 530. At the step 530, if the visit count in the accumulator is greater than a second predefined threshold, then control passes according to a YES arrow to a step 535. At the step 535, the program under consideration is classified as watched (rather than merely viewed), and the method 325 outputs the parameter WATCHED to the intentional watching list. If at the step 530 the number of visits is less that the second predefined threshold, then control passes according to a NO arrow to a step 540. At the step 540, the program is classified as unwatched, and the algorithm outputs the parameter UNWATCHED to the intentional watching list. When the step 535 is completed, or when the step 540 is completed, then the method 325 terminates and control passes back to method 300 in FIG. 6.

Returning to FIG. 4, if the threshold for meaningful (as set in the step 520 of FIG. 8) visits is made very short, then the program p₂ is visited seven times. If the threshold for a meaningful visit is raised to (t₆-t₅) then the program p₂ is visited only 4 times.

Both the threshold and visit algorithms treat the ‘flat’ parts of the event line 200 (see FIG. 4) as the features that are significant. However, a flat part of the event line 200 could indicate either that the viewer 101 is watching the program on the television 107, or alternately, that the viewer 101 is absent from the room. As noted, this problem can be ameliorated by detecting the presence of the watcher using the radiation that they emit and/or reflect, or using sonic or ultrasonic detection of the viewer. This information can be incorporated into the program flipping data as shown in FIG. 5. Furthermore, if the system 100 detects that the viewer has muted the volume from the TV 109, this can also be used to infer that the viewer is not watching the program.

The threshold method 320 (see FIG. 6) is extended to take the presence data (see 210 and 220 in FIG. 5) into account by altering the definition of overlap. The definition of overlap without taking presence data into account is the intersection of the duration of the event with the duration of the program. This definition can be extended to additionally intersect with the period of time for which a viewer is present. For example, in the absence of presence data, and having regard to FIG. 4, the event e₃ in FIG. 4 has an overlap with the program p₃ of duration <t₈, . . . ,t₁₀>. Taking the presence data 220 into account as shown in FIG. 5, however, the overlap between the event e₃ and the program p₃ is only <t₉, . . . ,t₁₀>.

The incorporation of presence data into the visit method of the step 325 in FIG. 6 is more complex.

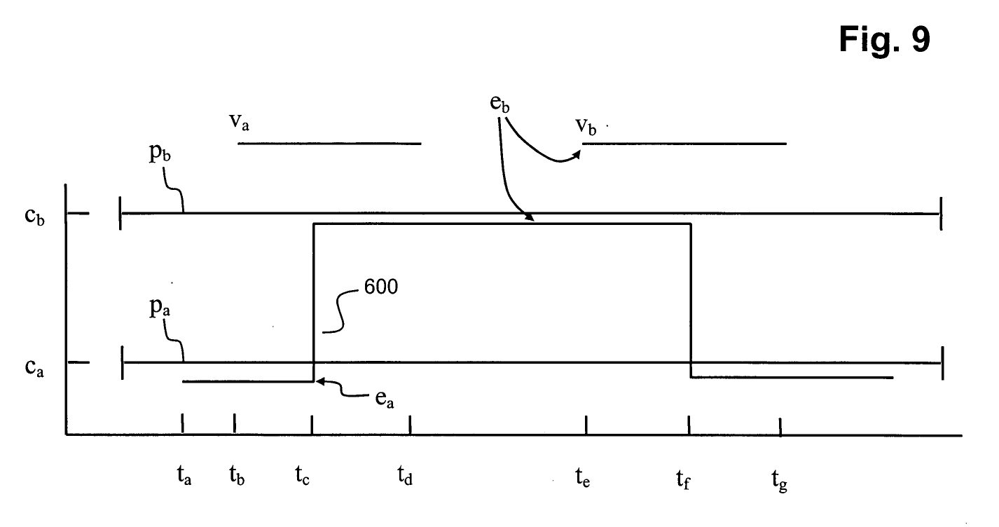

FIG. 9 shows program flipping data relating to two channels cₐ and c_{b}, and two programs pₐ, and p_{b}. The viewer is present in the room for the periods associated with presence data vₐ and v_{b}. Under the original algorithm, there would be one viewing event eₐ associated with the program p_{b}. This viewing event would have a duration t_{c} to t_{f}. However, since the viewer 101 is absent from the room during the period t_{d} to tₑ, there are actually two viewing events associated with the program. One viewing event eₐ having a duration t_{c} to t_{d}, and one viewing event e_{b} having a duration tₑ to t_{f}. Therefore, when the viewing events are extracted at step the 310 in FIG. 6, the viewing events are considered in light of the presence lines vₐ and v_{b} and the viewing events are modified according to the process above. These modified events can be given to the visit method 325 which then operates as shown in FIG. 8.

The threshold method 320 in FIG. 7 should preferably use a threshold of 0.33 at the step 425. The visit method 325 in FIG. 8 should use an event threshold of 60 seconds at the step 520 and a visit threshold of 2 at the step 530. Accordingly, a program is considered to be watched if the program is of the “sport” genre and there were two visits of at least 60 seconds each. Alternately, a program is considered to be watched if the genre is not sport, and at least one third of the program was watched.

Both the threshold and visit methods (ie the steps 320 and 325 in FIGS. 6-8) can be used to determine whether a viewer has watched a previously recorded program by analysing their playback behaviour using the VCR 114 or, equivalently, a DVD or other equivalent playback device (not shown). Accordingly, time periods during which the recorded program is being played back at normal speed can be considered to be equivalent to those times when the television is tuned to a particular program. Similarly, periods of FAST FORWARD or CUE FORWARD can be treated as being equivalent to the situation in which the television 109 is not tuned to a program (ie. the corresponding events are not co-incident with any program and so the “channel” field is null). In addition, the fact that a person is watching a recorded program is often a strong indicator that the program holds at least some interest for the viewer and is more probably watched than merely viewed.

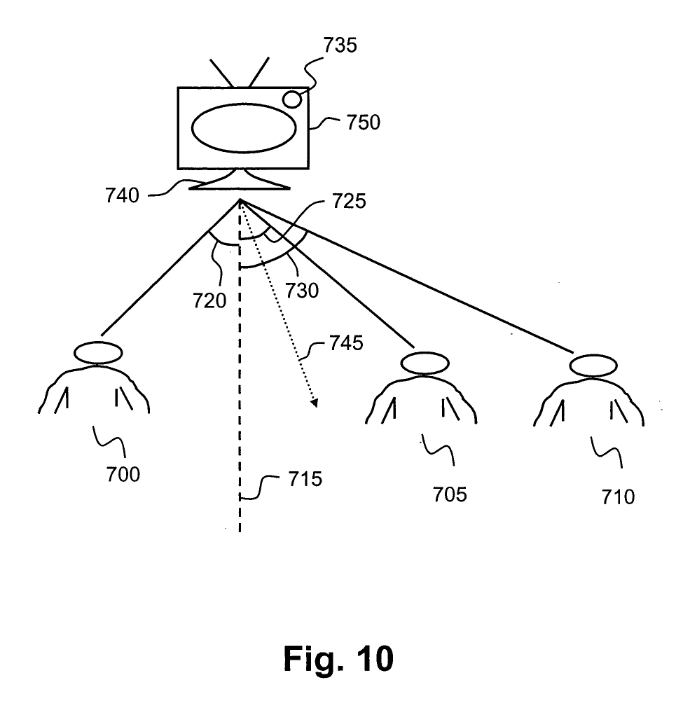

FIG. 10 shows a television 750 mounted on a stand 740 which can be rotated by means of a motorised drive (not shown) mounted in the stand 740. The arrangement has person-detection capability using either IR detection of a person's black body radiation, or alternately, ultrasonic or equivalent detection devices. The television can be rotated according to the detected presence information. FIG. 10 shows a scenario in which three people (700, 705, 710) are watching the television 735. A dotted line 715 is normal to the centre of the television screen. A sensor 735 detects, using the aforementioned IR or ultrasonic detection mechanisms, angles from the normal (720, 725, 730) at which each of the viewers (700, 705, 710 respectively) are watching the television 750. These detected viewing angles are the respective viewing angles for each of the viewers. Angles (such as 720) to the left of the normal 715 are considered to be negative, and angles (such as 725, 730) to the right of the normal 715 are considered to be positive. If the sum of these positive and negative angles is negative, then the television rotates to the right until the sum of the viewing angles is 0. Similarly, if the sum of the angles is positive, the television rotates left until the sum of the viewing angles is 0. In this manner, the TV 750 is rotated according to the spatial distribution of the viewers that are present in order to increase the viewing area of the TV 735 that is presented to each viewer.

### Industrial Applicability

It is apparent from the above that the arrangements described are applicable to the entertainment and marketing industries.

The foregoing describes only some embodiments of the present invention, and modifications and/or changes can be made thereto without departing from the scope and spirit of the invention, the embodiments being illustrative and not restrictive. Thus, for example, although the “events” in the description are described as being specific to their source (e.g. a remote control, or a dial on the television), the “events” can equally be associated with their effect on the TV.

1. A method of determining whether a viewer has watched a program, the method comprising the steps of:
accumulating program flipping data for the program;
determining metadata for the program;
selecting an algorithm dependent on the metadata; and
applying the selected algorithm to the program flipping data, to thereby extract intentional viewing data that establishes if the program has been watched by the viewer.

2. A method according to claim 1, wherein:
the selecting step comprises processing the metadata and selecting the algorithm dependent upon the processed metadata.

3. A method according to claim 1, wherein:
the selecting step is further dependent upon the program flipping data.

4. A method according to claim 1, wherein:
the viewing environment is based on broadcast viewing; and
the program flipping data comprises viewing events characterised by at least one of a channel identifier, an event duration, and a channel event state being one of ON, OFF, UP, DOWN and SET.

5. A method according to claim 1, wherein:
the viewing environment is based on recorded program viewing; and
the program flipping data comprises viewing events characterised by at least one of a duration, and a program state being one of ON, OFF, FAST FORWARD, CUE FORWARD, FAST REWIND and SET.

6. A method according to claim 1, wherein the metadata is the genre of the program.

7. A method according to claim 6, wherein the applying step comprises:
establishing a first threshold;
determining, from the channel flipping data, the number of viewing events that (a) have the same channel identifier as the program, (b) overlap with the program, and (c) have a duration exceeding the first threshold, to thereby determine the number of visits to the program;
defining a second threshold; and
classifying the program as being watched if the number of visits exceeds the second threshold.

8. A method according to claim 6, wherein the applying step comprises:
identifying, from the channel flipping data, the viewing events that (a) have the same channel identifier as the program, (b) overlap with the program;
determining the cumulative sum of the durations of the identified viewing events;
defining a threshold dependent upon the duration of the program; and
classifying the program as being watched if the cumulative sum exceeds the threshold.

9. A method according to claim 1, wherein the applying step further includes consideration of at least one of (a) information indicating a presence of the viewer during the program, and (b) information indicating that the volume of the TV has been muted during the program, to thereby determine whether the program has been watched.

10. A system for determining whether a viewer has watched a program, the system comprising:
means for accumulating program flipping data for the program;
means for determining metadata for the program;
means for selecting an algorithm dependent on the metadata; and
means for applying the selected algorithm to the program flipping data, to thereby extract intentional viewing data that establishes if the program has been watched by the viewer.

11. A system for determining whether a viewer has watched a program, the system comprising:
at least one processor; and
at least one program module for directing the processor to execute a method for determining whether the viewer has watched the program, said at least one program module comprising:
code for accumulating program flipping data for the program;
code for determining metadata for the program;
code for selecting an algorithm dependent on the metadata; and
code for applying the selected algorithm to the program flipping data, to thereby extract intentional viewing data that establishes if the program has been watched by the viewer.

12. A computer program for directing a processor to execute a method of determining whether a viewer has watched a program, the program comprising:
code for accumulating program flipping data for the program;
code for determining metadata for the program;
code for selecting an algorithm dependent on the metadata; and
code for applying the selected algorithm to the program flipping data, to thereby extract intentional viewing data that establishes if the program has been watched by the viewer.

13. A computer program product including a computer readable medium having recorded thereon a computer program for directing a processor to execute a method of determining whether a viewer has watched a program, the program comprising:
code for accumulating program flipping data for the program;
code for determining metadata for the program;
code for selecting an algorithm dependent on the metadata; and
code for applying the selected algorithm to the program flipping data, to thereby extract intentional viewing data that establishes if the program has been watched by the viewer.

14. Information about whether a viewer has watched a program, the information having been determined by a method comprising the steps of:
accumulating program flipping data for the program;
determining metadata for the program;
selecting an algorithm dependent on the metadata; and
applying the selected algorithm to the program flipping data, to thereby extract intentional viewing data that establishes if the program has been watched by the viewer.

15. Information about program flipping data used in a method for determining whether a viewer has watched a program, the program flipping data comprising viewing events characterised by at least one of a channel identifier, an event duration, and a channel event state being one of ON, OFF, UP, DOWN and SET.

16. Information about program flipping data used in a method for determining whether a viewer has watched a program, the program flipping data comprising viewing events characterised by at least one of a duration, and a program state being one of ON, OFF, FAST FORWARD, CUE FORWARD, FAST REWIND and SET.

17. A method of improving a viewing angle between at least one viewer watching a TV and the TV, the method comprising the steps of:
detecting spatial information about said at least one viewer relative to the TV; and
adjusting orientation of the TV to improve the viewing angle.

18. An apparatus for improving a viewing angle between at least one viewer watching a TV and the TV, the apparatus comprising:
means for detecting spatial information about said at least one viewer relative to the TV; and
means for adjusting orientation of the TV to improve the viewing angle.
